(19) United States
(12) Patent Application Publication
(10) Pub. No.: US 2016/0377929 A1
(43) Pub. Date: Dec. 29, 2016

(54) ARRAY SUBSTRATE AND DISPLAY DEVICE INCLUDING THE SAME

(71) Applicant: Samsung Display Co. Ltd., Yongin-City (KR)

(72) Inventor: Yong-Woon LIM, Seoul (KR)

(21) Appl. No.: 14/957,844

(22) Filed: Dec. 3, 2015

(30) Foreign Application Priority Data
Jun. 26, 2015 (KR) 10-2015-0090856

(51) Int. Cl. G02F 1/1343; G02F 1/1335; G02F 1/1333; G02F 1/1368; G02F 1/1362

(52) U.S. Cl. CPC G02F 1/134309; G02F 1/1368; G02F 1/136286; G02F 1/133345; G02F 1/136227; G02F 1/136209; G02F 1/133514; G02F 2201/40

(57) ABSTRACT

An array substrate includes: a base substrate on which a pixel area is defined, where the pixel area includes a first area and a second area, which surrounds the first area; and a pixel electrode disposed in the pixel area. The pixel electrode includes a stem, a center of which is located in the first area, and a plurality of branches, each of which includes a first portion extending from the stem and disposed in the first area and a second portion extending from the first portion and disposed in the second area, and a width of the first portion is different from a width of the second portion.

This application claims priority to Korean Patent Application No. 10-2015-0090856 filed on Jun. 26, 2015, and all the benefits accruing therefrom under 35 U.S.C. §119, the content of which in its entirety is herein incorporated by reference.

### BACKGROUND

1. Field

Exemplary embodiments of the invention relate to an array substrate and a display device including the array substrate.

2. Description of the Related Art

Generally, a liquid crystal display (“LCD”) device may include an array substrate, an opposite substrate facing the array substrate, and a liquid crystal layer interposed between the array substrate and the opposite substrate.

The LCD device displays an image by applying a voltage to the liquid crystal layer so as to control the transmission of light. Since in the LCD device, light is transmitted through the liquid crystal layer only in directions not blocked by liquid crystal molecules, the LCD device generally has a narrow viewing angle, compared to other display devices.

To improve viewing angle of the LCD device, various techniques for increasing the viewing angle of an LCD device have been developed. For example, in a patterned vertical alignment (“PVA”)-mode LCD device, liquid crystal molecules are aligned in different directions with the use of patterned pixel electrodes to form liquid crystal domains and thus to improve the viewing angle. However, since in the PVA-mode LCD device, switching devices such as thin-film transistors (“TFT”s), wiring such as gate lines and data lines, and pixel electrodes are formed on the same array substrate, the aperture ratio may easily decrease.

### SUMMARY

Exemplary embodiments of the invention provide an array substrate with an improved aperture ratio and display quality and a display device including the array substrate.

However, exemplary embodiments of the invention are not restricted to those set forth herein. The above and other exemplary embodiments of the invention will become more apparent to one of ordinary skill in the art to which the invention pertains by referencing the detailed description of the invention given below.

According to an exemplary embodiment of the invention, an array substrate includes: a base substrate on which a pixel area is defined, where the pixel area includes a first area and a second area, which surrounds the first area; and a pixel electrode disposed in the pixel area. In such an embodiment, the pixel electrode includes a stem, a center of which is located in the first area, and a plurality of branches, each of which includes a first portion extending from the stem and disposed in the first area and a second portion extending from the first portion and disposed in the second area, and a width of the first portion is different from a width of the second portion.

According to an exemplary embodiment of the invention, a display device includes: an array substrate; an opposite substrate disposed opposite to the array substrate and including a common electrode; and a liquid crystal layer interposed between the array substrate and the opposite substrate. In such an embodiment, the array substrate includes: a base substrate on which a pixel area is defined, where the pixel area includes a first area and a second area, which surrounds the first area; and a pixel electrode disposed in the pixel area, the pixel electrode includes a stem, a center of which is located in the first area, and a plurality of branches, each of which includes a first portion extending from the stem and disposed in the first area and a second portion extending from the first portion and disposed in the second area, and a width of the first portion is different from a width of the second portion.

According to exemplary embodiments, a display device including the array substrate may have an improved aperture ratio and display quality.

Other features and exemplary embodiments will be apparent from the following detailed description, the drawings, and the claims.

### BRIEF DESCRIPTION OF THE DRAWINGS

The above and other features of the inventive concept will become more apparent by describing in detail exemplary embodiments thereof with reference to the attached drawings, in which:

FIG. 1 is a schematic plan view of a display device according to an exemplary embodiment of the invention;

FIG. 2 is an enlarged view of the portion A of FIG. 1;

FIG. 3 is a cross-sectional view taken along lines X1-X1′ and X2-X2′ of the display device of FIG. 1;

FIG. 4 is a schematic plan view of a display device according to an alternative exemplary embodiment of the invention;

FIG. 5 is an enlarged view of the portion B of FIG. 4; and

FIG. 6 is a cross-sectional view taken along lines Y1-Y1′ and Y2-Y2′ of the display device of FIG. 4.

### DETAILED DESCRIPTION

Features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the inventive concept will only be defined by the appended claims. Like reference numerals refer to like elements throughout the specification.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, a region illustrated as a rectangle will, sometimes, have rounded or curved features and/or a gradient of concentration at its edges rather than a binary change between regions. Thus, the regions illustrated in the figures are schematic in nature and their shapes may not be intended to illustrate the actual shape of a region of a device and are not intended to limit the scope of the inventive concept.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the disclosure.

Unless otherwise defined, all terms (including technical and scientific terms) used herein have the same meaning as commonly understood by one of ordinary skill in the art to which the present application belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Exemplary embodiments of the invention will hereinafter be described with reference to the accompanying drawings.

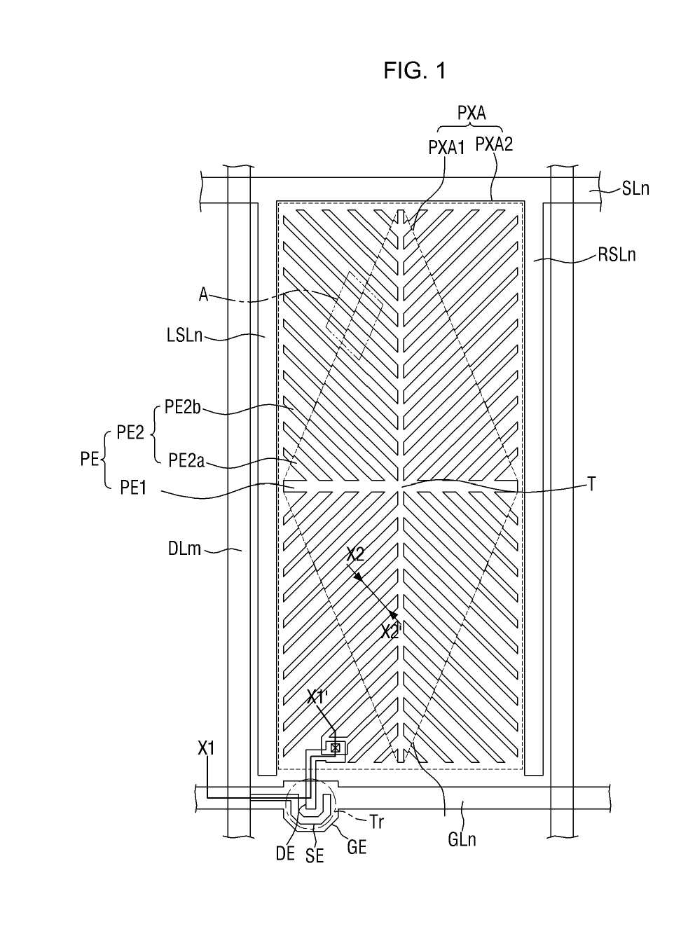

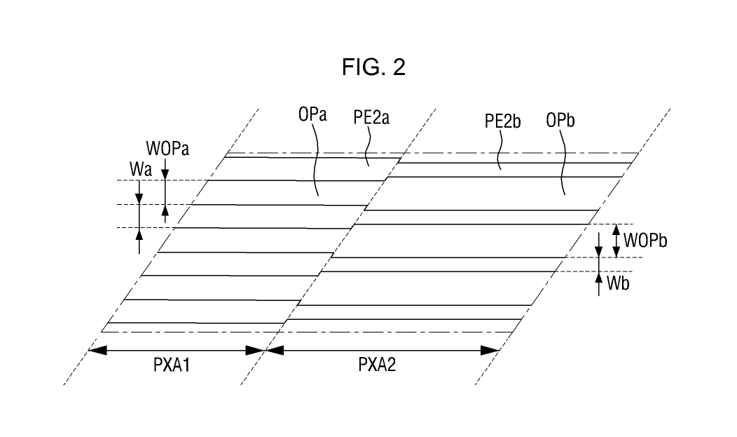

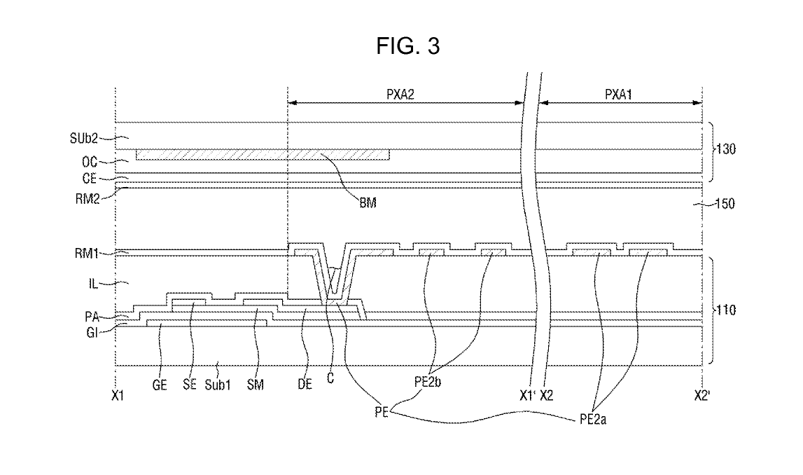

FIG. 1 is a schematic plan view of a display device according to an exemplary embodiment of the invention, FIG. 2 is an enlarged view of the portion A of FIG. 1, and FIG. 3 is a cross-sectional view taken along lines X1-X1′ and X2-X2′ of the display device of FIG. 1.

Referring to FIGS. 1 to 3, an exemplary embodiment of the display device may include an array substrate 110, an opposite substrate 130, and a liquid crystal layer 150.

The array substrate 110 may be a thin-film transistor (“TFT”) array substrate in which TFTs for driving liquid crystal molecules in the liquid crystal layer 150 are disposed, and the opposite substrate 130 may be a substrate facing the array substrate 110.

The array substrate 110 will hereinafter be described in detail.

In such an embodiment, a first base substrate SUB1 may be a transparent insulating substrate. In one exemplary embodiment, for example, the first base substrate SUB1 may be a glass substrate, a quartz substrate or a transparent resin substrate. The first base substrate SUB1 may include a polymer or plastic material with high heat resistance.

In some exemplary embodiments, the first base substrate SUB1 may have flexibility. In such embodiments, the first base substrate SUB1 may be a substrate that may be transformed by rolling, folding or bending.

A gate line GLn and a gate conductor including a gate electrode GE may be disposed on the first base substrate SUB1. The gate line GLn may transmit a gate signal and may extend substantially or mostly in a horizontal direction, as shown in FIG. 1. The gate line GLn may include the gate electrode GE. The gate line GLn may include an aluminum (Al)-based metal such as Al or an Al alloy, a silver (Ag)-based metal such as Ag or an Ag alloy, a copper (Cu)-based metal such as Cu or a Cu alloy, a molybdenum (Mo)-based metal such as Mo or a Mo alloy, chromium (Cr), tantalum (Ta), or titanium (Ti). The gate line GLn may have a single-layer structure or a multilayer structure including a plurality of conductive films having different physical properties from each other, in which one of the conductive films may include or be formed of a low-resistance metal, for example, an AL-based metal, an Ag-based metal, or a Cu-based metal, to reduce signal delays or voltage drops in the gate line GLn and another of the conductive films may include or be formed of another material, such as a material with excellent contact properties with respect to indium tin oxide (“ITO”) and indium zinc oxide (“IZO”), such as a Mo-based metal, Cr, Ti, or Ta. In an exemplary embodiment, where the gate line GLn has the multilayer structure, the gate line GLn include the combination of a Cr lower film and an Al upper film, and the combination of an Al lower film and a Mo upper film, for example.

The gate electrode GE may protrude from the gate line GLn and may be connected to the gate line GLn.

A gate insulating layer GI may be disposed on the gate line GLn and the gate electrode GE. The gate insulating layer GI may include or be formed of an insulating material, for example, silicon nitride or silicon oxide. The gate insulating layer GI may have a single-layer structure or a multilayer structure including a plurality of insulating layers having different physical properties from each other.

A semiconductor layer SM may be disposed on the gate insulating layer GI, and may at least partially overlap the gate electrode GE. The semiconductor layer SM may include amorphous silicon, polycrystalline silicon, or an oxide semiconductor, for example.

Although not specifically illustrated, a resistive contact member may be disposed on the semiconductor layer SM. The resistive contact member may include or be formed of silicide or n+ hydrogenated amorphous silicon doped with n-type impurities. A pair of resistive contact members may be disposed on the semiconductor layer SM. In some exemplary embodiments, where the semiconductor layer SM includes an oxide semiconductor, the resistive contact member(s) may be omitted.

A data conductor may be disposed on the semiconductor layer SM and the gate insulating layer GI. The data conductor may include a data line DLm.

The data line DLm may transmit a data signal and may extend substantially or mostly in a vertical direction, intersecting the gate line GLn as shown in FIG. 1. The data line DLm and the gate line GLn may be insulated from each other and may intersect each other, thereby defining a predefined area. The predefined area may include a pixel area PXA. The pixel area PXA may be an area where a pixel electrode PE is provided.

The pixel area PXA may include a first area PXA1 and a second area PXA2, which surrounds the first area PXA1. In some exemplary embodiments, the first area PXA1 may be in the shape of a quadrangle, and particularly, a rhombus, in a plan view, but the invention is not limited thereto. In an alternative exemplary embodiments, the first area PXA1 may be in various other shapes in a plan view. The second area PXA2 may surround the first area PXA1. The second area PXA2 may be defined by the entire pixel area PXA excluding the first area PXA1.

The ratio of the area of the first area PXA1 to the area of the second area PXA2 may be determined in various manners. In some exemplary embodiments, the ratio of the area of the first area PXA1 to the area of the second area PXA2 may be about 1:1, as illustrated in FIGS. 1 to 3, but the invention is not limited thereto. In an alternative exemplary embodiment, the first area PXA1 may be smaller than the second area PXA2, or may be larger than the second area PXA2.

A source electrode SE may be branched off from the data line DLm and may at least partially overlap the gate electrode GE. The source electrode SE is illustrated in FIGS. 1 to 3 as overlapping the gate line GLn, but the invention is not limited thereto.

A drain electrode DE may be isolated or spaced apart from the source electrode SE with the semiconductor layer SM interposed therebetween, and may at least partially overlap the gate electrode GE. The drain electrode DE is illustrated in FIGS. 1 to 3 as overlapping the gate line GLn, but the invention is not limited thereto.

The data conductor may include or be formed of Al, Cu, Ag, Mo, Cr, Ti, Ta or an alloy thereof. The data conductor may have a multilayer structure including a lower film (not illustrated) including or formed of a refractory metal and a low-resistance upper film (not illustrated) on the lower film, but the invention is not limited thereto.

The gate electrode GE, the source electrode SE and the drain electrode DE may collectively define a TFT Tr together with the semiconductor layer SM, and the channel of the TFT Tr may be defined or formed in the semiconductor layer SM between the source electrode SE and the drain electrode DE. The TFT Tr may be electrically connected to the gate line GLn and the data line DLm.

A passivation layer PA may be disposed on the gate insulating layer GI and the TFT Tr. The passivation layer PA may include or be formed of an organic insulating material or an inorganic insulating material, and may cover the TFT Tr.

An insulating layer IL may be disposed on the passivation layer PA. In some exemplary embodiments, the insulating layer IL may have the function of planarizing the top of the passivation layer PA. The insulating layer IL may include or be formed of an organic material. In some exemplary embodiments, the insulating layer IL may include or be formed of a photosensitive insulating material, but the invention is not limited thereto. In some alternative exemplary embodiments, the insulating layer IL may include or be formed of a material including a photosensitive organic composition and a pigment for realizing a color. In one exemplary embodiment, for example, the insulating layer IL may include a photosensitive organic composition including one of a red pigment, a green pigment and a blue pigment. In such an embodiment, the insulating layer IL may define a color filter. A contact hole C, which exposes part of the TFT Tr, and particularly, part of the drain electrode DE, therethrough, may be defined or formed through the insulating layer IL and the passivation layer PA.

The pixel electrode PE may be disposed on the insulating layer IL. Part of the pixel electrode PE may be physically and electrically connected to the drain electrode DE via the contact hole C and may thus receive a voltage from the drain electrode DE.

The pixel electrode PE may include or be formed of a transparent conductive material such as ITO, IZO, indium tin zinc oxide (“ITZO”), or Al-doped zinc oxide (“AZO”).

The pixel electrode PE may include a stem PE1, which is cross-shaped, and a plurality of branches PE2, which extend from the stem PE1. The pixel electrode PE or the pixel area PXA may be divided into a plurality of domains by the stem PE1, which is cross-shaped. In one exemplary embodiment, for example, the pixel electrode PE or the pixel area PXA may be divided into four domains by the stem PE1, which is cross-shaped, as illustrated in FIG. 1.

A center T of the stem PE1 may be located in the first area PXA1 of the pixel area PXA. The center T may be the intersection between a horizontal portion and a vertical portion of the stem PE1, which is cross-shaped.

The branches PE2 may extend diagonally outwardly from the stem PE1, which is cross-shaped, and the branches PE2 in different domains defined by the stem PE1 may be aligned along different directions from each other. The branches PE2 may be isolated or spaced apart from one another not to meet one another. In an exemplary embodiment, an isolation space OPa or OPb may exist between a pair of adjacent branches PE2. The branches PE2 may extend substantially in the same direction or substantially in parallel to one another in each of the domains defined by the stem PE1. The branches PE2 may be in symmetry with respect to at least one of the horizontal and vertical portions of the stem PE1, which is cross-shaped.

Each of the branches PE2 may include a first portion PE2a, which is located in the first area PXA1, and a second portion PE2b, which is located in the second area PXA2. The first portion PE2a may be connected to the stem PE1, and the second portion PE2b may be connected to the first portion PE2a. In such an embodiment, the first portion PE2a may extend from the stem PE1, and the second portion PE2b may extend from the first portion PE2a.

A width Wa of the first portion PE2a may differ from a width Wb of the second portion PE2b. In some exemplary embodiments, the width Wa of the first portion PE2a may be greater than the width Wb of the second portion PE2b.

The distance between a pair of adjacent first portions PE2a may differ from the distance between a pair of adjacent second portions PE2b. In an exemplary embodiment, as shown in FIG. 2, when the space between the pair of adjacent first portions PE2a is referred to as a first isolation OPa and the space between the pair of adjacent second portions PE2b is referred to as a second isolation OPb, a width WOPa of the first isolation OPa may differ from a width WOPb of the second isolation OPb. In some exemplary embodiments, the distance between the pair of adjacent first portions PE2a may be smaller than the distance between the pair of adjacent second portions PE2b.

In some exemplary embodiments, the sum of the width Wa and the width WOPa may be substantially the same as the sum of the width Wb and the width WOPb. That is, when the interval of repetition of a first portion PE2a is defined as a first pitch and the interval of repetition of a second portion PE2b is defined as a second pitch, the first pitch may be substantially the same as or equal to about the second pitch.

In one exemplary embodiment, for example, the pixel area PXA or the pixel electrode PE may be divided into four domains by the stem PE1. The pixel area PXA may be divided into the first area PXA1 and the second area PXA2, and the width of the branches PE2 and the distance between the branches PE2 may vary from the first area PXA1 to the second area PXA2. In such an embodiment, each of the four domains defined by the stem PE1 may be further divided into the first area PXA1 where the first portions PE2a of the branches PE2 are located and the second area PXA2 where the second portions PE2b of the branches PE2 are located. Accordingly, the pixel area PXA or the pixel electrode PE may be divided into a total of eight sub-domains, but the invention is not limited thereto. In an alternative exemplary embodiment, the pixel area PXA may be divided into three or more areas, in which case, each of the branches PE2 may include a portion disposed in a third area other than the first area PXA1 and the second area PXA2, in addition to a first portion PE2a disposed in the first area PXA1 and a second portion PE2b disposed in the second area PXA2. In some exemplary embodiments, the first portions PE2a and the second portions PE2b of the branches PE2 may be provided only in some of the domains defined by the stem PE1.

In some exemplary embodiments, a storage electrode may be disposed on the first base substrate SUB1. The storage electrode may include a storage line SLn, which extends in the same direction as the gate line GLn, and first and second branch electrodes LSLn and RSLn, which are branched off from the storage line SLn and extend in the same direction as the data line DLm. In some exemplary embodiments, the pixel electrode PE may partially overlap the storage line SLn and the first and second branch electrodes LSLn and RSLn, thereby defining a storage capacitor. The first and second branch electrodes LSLn and RSLn may block a coupling electric field that may be generated between the data line DLm and the pixel electrode PE.

The opposite substrate 130 will hereinafter be described in detail.

The opposite substrate 130 may include a second base substrate SUB2, a light-blocking member BM and a common electrode CE, and may further include an overcoat layer OC.

The light-blocking member BM may be disposed on the second base substrate SUB2. The light-blocking member BM may be disposed to overlap the TFT Tr, the data line DLm, and the gate line GLn, and may effectively prevent light leakage that may occur due to the misalignment of liquid crystal molecules. The light-blocking member 220 may include a light-blocking pigment such as black carbon and may further include a photosensitive organic material.

The overcoat layer OC may be disposed on the second base substrate SUB2 and the light-blocking member BM, and may reduce a step difference generated by the light-blocking member BM. In an alternative exemplary embodiments, the overcoat layer OC may be omitted.

The common electrode CE may be disposed on the overcoat layer OC. In some exemplary embodiments, where the overcoat layer OC is not provided, the common electrode CE may be disposed on the second base substrate SUB2 and the light-blocking member BM. The common electrode CE may include or be formed of a transparent conductive material, and may be disposed on the entire surface of the second base substrate SUB2. A common voltage may be applied to the common electrode CE, and as a result, the common electrode CE may generate an electric field together with the pixel electrode PE.

The liquid crystal layer 150 will hereinafter be described in detail.

The liquid crystal layer 150 may include a plurality of liquid crystal molecules with dielectric anisotropy. The liquid crystal molecules may be vertical alignment (“VA”)-mode liquid crystal molecules, which are aligned between the array substrate 110 and the opposite substrate 130 in a direction substantially perpendicular to the array substrate 110 and the opposite substrate 130. In response to an electric field generated between the array substrate 110 and the opposite substrate 130, the liquid crystal molecules may be rotated in a particular direction between the array substrate 110 and the opposite substrate 130 to control, e.g., allow or block, the transmission of light therethrough. The rotation of the liquid crystal molecules may not only mean that the liquid crystal molecules are actually rotated physically, but may also mean that the alignment of the liquid crystal molecules is changed by an electric field.

Reactive mesogen layers RM1 and RM2 may pretilt the liquid crystal molecules in the liquid crystal layer 150. The reactive mesogen layers RM1 and RM2 may include a first reactive mesogen layer RM1, which is disposed between the pixel electrode PE and the liquid crystal layer 150, and a second reactive mesogen layer RM2, which is disposed between the common electrode CE and the liquid crystal layer 150.

Reactive mesogen is a material having similar properties to conventional or typical liquid crystal molecules, and may be in the form of a polymer obtained by polymerizing the photo-reactive monomers. The reactive mesogen layers RM1 and RM2 may be formed by applying light such as ultraviolet (“UV”) light to the photo-reactive monomers to polymerize the photo-reactive monomers.

The photo-reactive monomers may be included in the liquid crystal layer 150. In one exemplary embodiment, for example, the liquid crystal layer 150 may include not only liquid crystal molecules, but also the photo-reactive monomers. The reactive mesogen layers RM1 and RM2 may be formed by applying, for example, UV light, to the liquid crystal layer 150 with an electric field being applied to the liquid crystal layer 150 to cure the photo-reactive monomers.

The polymer obtained by polymerizing the photo-reactive monomers may extend in a predetermined direction to form a pretilt angle and to pretilt the liquid crystal molecules in the liquid crystal layer 150. In such an embodiment, the liquid crystal molecules in the liquid crystal layer 150 may be pretilted at a predetermined angle by the reactive mesogen layers RM1 and RM2 having the pretilt angle. Pretilted liquid crystal molecules may have a higher response speed than non-pretilted liquid crystal molecules in response to an electric field being applied. The reactive mesogen layers RM1 and RM2 may function as directors of the liquid crystal layer 150.

The reactive mesogen layers RM1 and RM2 may have a different pretilt angle in the first area PXA1 than in the second area PXA2. The first portions PE2a of the branches PE2, which are disposed in the first area PXA1, may have a different width from the second portions PE2b of the branches PE2, which are disposed in the second area PXA2, and accordingly, an electric field generated by the pixel electrode PE and the common electrode CE may vary from the first area PXA1 to the second area PXA2. Thus, in response to light such as UV light being applied to the liquid crystal layer 150 with an electric field being applied to the liquid crystal layer 150, an electric field generated in the first area PXA1 may differ from an electric field generated in the second area PXA2, and accordingly, the reactive mesogen layers RM1 and RM2 may have a different pretilt angle in the first area PXA1 than in the second area PXA2. In one exemplary embodiment, for example, due to the width Wa of the first portions PE2a of the branches PE2 being greater than the width Wb of the second portions PE2b of the branches PE2, the reactive mesogen layers RM1 and RM2 may have a larger pretilt angle in the first area PXA1 than in the second area PXA2. Accordingly, in a state when an electric field is yet to be applied, the pretilt angle of liquid crystal molecules in the first area PXA1 may be larger than the pretilt angle of liquid crystal molecules in the second area PXA2.

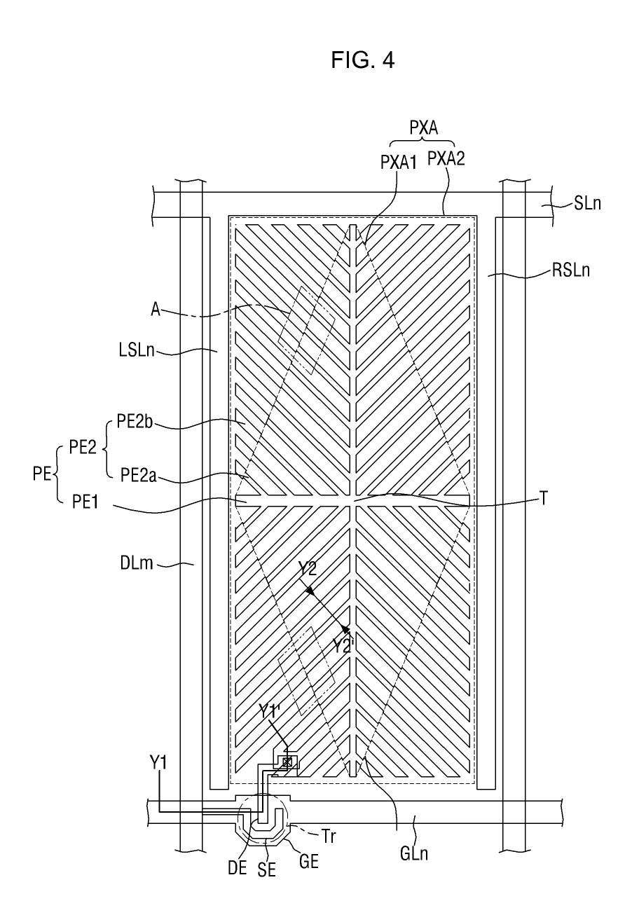

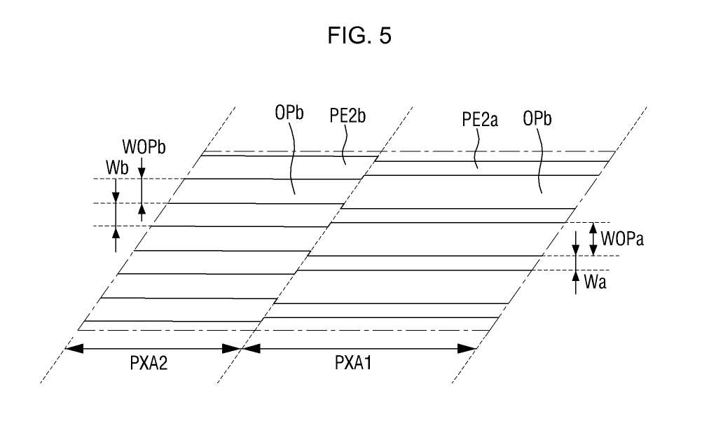

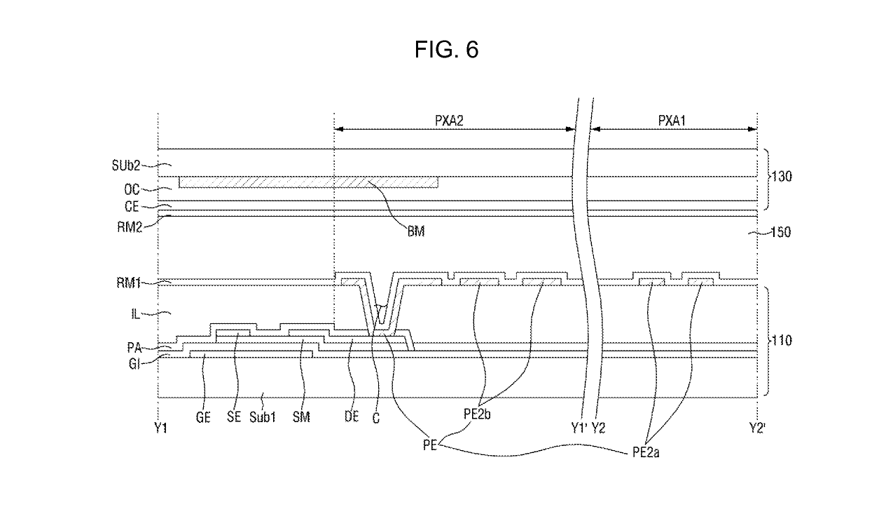

FIG. 4 is a schematic plan view of a display device according to an alternative exemplary embodiment of the invention, FIG. 5 is an enlarged view of the portion B of FIG. 4, and FIG. 6 is a cross-sectional view taken along lines Y1-Y1′ and Y2-Y2′ of the display device of FIG. 4.

In the exemplary embodiments described above with reference to FIGS. 1 to 3 and such exemplary embodiments shown in FIGS. 4 to 6, like reference numerals indicate like elements, and any repetitive detailed descriptions thereof will be omitted. Hereinafter, for convenience of description, different features of such an embodiments shown in FIGS. 4 to 6 from the exemplary embodiments, described above with reference to FIGS. 1 to 3, will be described in detail.

Referring to FIGS. 4 to 6, an exemplary embodiment of the display device may include an array substrate 110, an opposite substrate 130, and a liquid crystal layer 150.

The array substrate 110 may be a TFT array substrate in which TFTs for driving liquid crystal molecules in the liquid crystal layer 150 are disposed, and the opposite substrate 130 may be a substrate facing the array substrate 110.

The array substrate 110 will hereinafter be described in detail.

The array substrate 110 may be substantially the same as of the described above with reference to FIGS. 1 to 3 except for the shape of a pixel electrode PE, and for convenience of described, any repetitive detailed description thereof will be omitted.

A pixel electrode PE may be disposed on an insulating layer IL. Part of the pixel electrode PE may be physically and electrically connected to a drain electrode DE via a contact hole C and may thus receive a voltage from the drain electrode DE.

The pixel electrode PE may include or be formed of a transparent conductive material such as ITO, IZO, ITZO, or AZO.

The pixel electrode PE may include a stem PE1, which is cross-shaped, and a plurality of branches PE2, which extend from the stem PE1.

A center T of the stem PE1 may be located in a first area PXA1 of a pixel area PXA.

The branches PE2 may extend diagonally outwardly from the stem PE1, which is cross-shaped, and may be aligned along different directions in different domains defined by the stem PE1. Each of the branches PE2 may include a first portion PE2a, which is located in the first area PXA1, and a second portion PE2b, which is located in a second area PXA2 of the pixel area PXA. The first portion PE2a may be connected to the stem PE1, and the second portion PE2b may be connected to the first portion PE2a. In such an embodiment, the first portion PE2a may extend from the stem PE1, and the second portion PE2b may extend from the first portion PE2a.

In an exemplary embodiment, a width Wa of the first portion PE2a may differ from a width Wb of the second portion PE2b. In some exemplary embodiments, as shown in FIGS. 4 to 6, the width Wa of the first portion PE2a may be smaller than the width Wb of the second portion PE2b.

The distance between a pair of adjacent first portions PE2a may differ from the distance between a pair of adjacent second portions PE2b. In an exemplary embodiment, a width WOPa of a first isolation OPa between the pair of adjacent first portions PE2a may differ from a width WOPb of a second isolation OPb between the pair of adjacent second portions PE2b. In some exemplary embodiments, the distance between the pair of adjacent first portions PE2a may be greater than the distance between the pair of adjacent second portions PE2b.

In some exemplary embodiments, the sum of the width Wa and the width WOPa may be substantially the same as the sum of the width Wb and the width WOPb. In such embodiments, when the interval of repetition of a first portion PE2a is defined as a first pitch and the interval of repetition of a second portion PE2b is defined as a second pitch, the first pitch may be substantially the same as or equal to about the second pitch.

The opposite substrate 130 will hereinafter be described in detail.

The opposite substrate 130 may include a second base substrate SUB2, a light-blocking member BM and a common electrode CE, and may further include an overcoat layer OC. The opposite substrate 130 is substantially the same as that described above with reference to FIGS. 1 through 3.

The liquid crystal layer 150 will hereinafter be described in detail.

The liquid crystal layer 150 may include a plurality of liquid crystal molecules with dielectric anisotropy. The liquid crystal molecules may be VA-mode liquid crystal molecules, which are aligned between the array substrate 110 and the opposite substrate 130 in a direction perpendicular to the array substrate 110 and the opposite substrate 130.

Reactive mesogen layers RM1 and RM2 may pretilt the liquid crystal molecules in the liquid crystal layer 150. The reactive mesogen layers RM1 and RM2 may include a first reactive mesogen layer RM1, which is disposed between the pixel electrode PE and the liquid crystal layer 150, and a second reactive mesogen layer RM2, which is disposed between the common electrode CE and the liquid crystal layer 150.

The reactive mesogen layers RM1 and RM2 may have a different pretilt angle in the first area PXA1 than in the second area PXA2. In one exemplary embodiment, for example, in response to the width Wa of the first portion PE2a being smaller than the width Wb of the second portion PE2b, the reactive mesogen layers RM1 and RM2 may have a smaller pretilt angle in the first area PXA1 than in the second area PXA2. Accordingly, in a state when an electric field is yet to be applied, the pretilt angle of liquid crystal molecules in the first area PXA1 may be smaller than the pretilt angle of liquid crystal molecules in the second area PXA2.

According to exemplary embodiments of the invention, as described herein, a plurality of domains, for example, eight domains, may be provided using a single pixel electrode PE in each pixel. Accordingly, in such an embodiment lateral visibility may be improved by a single pixel electrode PE. In such embodiments, by using a single pixel electrode PE to provide multiple domains, the number of TFTs Tr to be used may be reduced. Accordingly, the size of a light-blocking member BM may be reduced, and the aperture ratio of an LCD device may be improved.

While the invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. An array substrate, comprising:
a base substrate on which a pixel area is defined, wherein the pixel area comprises a first area and a second area, which surrounds the first area; and
a pixel electrode disposed in the pixel area,
wherein the pixel electrode comprises:
a stem, a center of which is located in the first area; and
a plurality of branches extending from the stem,
wherein each of the branches comprises:
a first portion extending from the stem and disposed in the first area; and
a second portion extending from the first portion and disposed in the second area, and
wherein a width of the first portion is different from a width of the second portion.

2. The array substrate of claim 1, wherein
the stem divides the pixel area into a plurality of domains, and
the branches in different domains extend in different directions from each other.

3. The array substrate of claim 1, wherein a first distance between a pair of adjacent first portions is different from a second distance between a pair of adjacent second portions.

4. The array substrate of claim 3, wherein a sum of the width of the first portion and the first distance is equal to about a sum of the width of the second portion and the second distance.

5. The array substrate of claim 3, wherein
the width of the first portion is smaller than the width of the second portion, and
the first distance is greater than the second distance.

6. The array substrate of claim 3, wherein
the width of the first portion is greater than the width of the second portion, and
the first distance is smaller than the second distance.

7. The array substrate of claim 1, wherein a pitch of the first portion is equal to about a pitch of the second portion.

8. The array substrate of claim 1, wherein the first area is quadrangular in a plan view.

9. The array substrate of claim 1, further comprising:
a gate line disposed on the base substrate;
a data line disposed on the base substrate and crossing the gate line while being insulated from the gate line; and
a thin-film transistor connected to the gate line and the data line,
wherein the pixel electrode is connected to the thin-film transistor.

10. The array substrate of claim 9, further comprising:
an insulating layer disposed on the base substrate and covering the thin-film transistor,
wherein the pixel electrode is disposed on the insulating layer and is connected to the thin-film transistor via a contact hole, which is defined through the insulating layer.

11. The array substrate of claim 10, wherein the insulating layer defines a color filter.

12. A display device, comprising:
an array substrate;
an opposite substrate disposed opposite to the array substrate and comprising a common electrode; and
a liquid crystal layer interposed between the array substrate and the opposite substrate,
wherein the array substrate comprises:
a base substrate on which a pixel area is defined, wherein the pixel area comprises a first area and a second area, which surrounds the first area; and
a pixel electrode disposed in the pixel area, wherein the pixel electrode comprises a stem, a center of which is located in the first area, and a plurality of branches extending from the stem,
wherein each of the branches comprises:
a first portion extending from the stem and disposed in the first area; and
a second portion extending from the first portion and disposed in the second area,
wherein a width of the first portion is different from a width of the second portion.

13. The display device of claim 12, wherein
the stem divides the pixel area into a plurality of domains, and
the branches in different domains extend in different directions from each other.

14. The display device of claim 12, wherein a first distance between a pair of adjacent first portions is different from a second distance between a pair of adjacent second portions.

15. The display device of claim 12, wherein a pitch of the first portion is equal to about a pitch of the second portion.

16. The display device of claim 12, wherein the first area is quadrangular in a plan view.

17. The display device of claim 12, wherein the array substrate further comprises:
a gate line disposed on the base substrate;
a data line disposed on the base substrate and crossing the gate line while being insulated from the gate line;
a thin-film transistor connected to the gate line and the data line; and
to an insulating layer disposed on the base substrate and covering the thin-film transistor,
wherein the pixel electrode is disposed on the insulating layer and is connected to the thin-film transistor via a contact hole, which is defined through the insulating layer.

18. The display device of claim 17, wherein the opposite substrate further comprises a light-blocking member, which overlaps the thin-film transistor.

19. The display device of claim 17, wherein the insulating layer defines a color filter.
